(19) United States
(12) Patent Application Publication
(10) Pub. No.: US 2024/0302484 A1
(43) Pub. Date: Sep. 12, 2024

(54) ULTRA-WIDEBAND RANGING AND LOCATION TRACKING

(71) Applicant: Cisco Technology, Inc., San Jose, CA (US)

(72) Inventors: Robert Blaudia Badea, Broadview Heights, OH (US); Fred Jay Anderson, Lakeville, OH (US); Navid Pourramzan Gandji, Fremont, CA (US); Sivadeep Reddy Kalavakuru, Akron, OH (US)

(73) Assignee: Cisco Technology, Inc., San Jose, CA (US)

(21) Appl. No.: 18/601,666

(22) Filed: Mar. 11, 2024

Related U.S. Application Data
(60) Provisional application No. 63/489,753, filed on Mar. 11, 2023.

(51) Int. Cl. G01S 5/02; G01S 11/02; H04W 64/00

(52) U.S. Cl. CPC G01S 5/0284; G01S 11/02; H04W 64/003

(57) ABSTRACT

Ultra-Wideband (UWB) ranging and location tracking, and particularly an UWB antenna array system and methods for improving the accuracy for Phase-Difference-of-Arrival (PDOA) is provided. UWB ranging may include receiving a poll signal from a client via a first and second antenna. PDOA between the first and second antenna is determined based on the poll signal. A response signal is transmitted to the client, and a first portion of a final signal is received via the first antenna and a third antenna and a second portion of the final signal is received via the second and third antenna. PDOA between the first and third antenna is determined based on the first portion, and PDOA between the second and third antenna is determined based on the second portion. The client location is then determined based on the PDOAs.

### RELATED APPLICATION

Under provisions of 35 U.S.C. § 119(e), Applicant claims benefit of U.S. Provisional Application No. 63/489,753, filed Mar. 11, 2023, which is incorporated herein by reference.

### TECHNICAL FIELD

The present disclosure relates generally to Ultra-Wideband (UWB) ranging and location tracking, and particularly to an UWB antenna array system and methods for improving the accuracy for Phase-Difference-of-Arrival (PDOA) for client ranging and location tracking.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for UWB ranging;

FIG. 2 is a perspective view of a UWB antenna array system for UWB ranging;

FIG. 3 is a block diagram of a UWB antenna;

FIG. 4 is a signal diagram of a UWB ranging signal process;

FIG. 5 is a block diagram of a client position determination environment;

FIG. 6 is a side view of a UWB antenna range;

FIG. 7 is an overhead view of a UWB antenna range;

FIG. 8 is a flow chart of a method for UWB ranging;

FIG. 9 is a flow chart of a method for determining client location using UWB ranging; and

FIG. 10 is a block diagram of a computing device.

### DETAILED DESCRIPTION

### Overview

Ultra-Wideband (UWB) ranging and location tracking, and particularly an UWB antenna array system and methods for improving the accuracy for Phase-Difference-of-Arrival (PDOA) for client ranging and location tracking may be provided. UWB ranging may include receiving a poll signal from a client via a first antenna and a second antenna. A PDOA between the first antenna and the second antenna is determined based on the poll signal. A response signal is transmitted to the client, and a first portion of a final signal is received via the first antenna and a third antenna and a second portion of the final signal is received via the second antenna and the third antenna. A PDOA between the first antenna and the third antenna is determined based on the first portion of the final signal, and a PDOA between the second antenna and the third antenna is determined based on the second portion of the final signal. The client location is determined based on the PDOA between the first antenna and the second antenna, the PDOA between the first antenna and the third antenna, and the PDOA between the second antenna and the third antenna.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Modern communication systems employing UWB technology can offer a significant advancement in client ranging and location tracking capabilities when compared to existing techniques. UWB communication can provide enhanced accuracy, enabling precise ranging and/or client location tracking in various scenarios. For example, UWB tracking may have an error margin of less than ten centimeters in Line of Sight (LoS) scenarios and less than fifty centimeters in Non-Line of Sight (NLoS) scenarios.

Existing implementations for performing client tracking and ranging typically include utilizing Time of Flight (ToF) measurements. ToF measurements may be executed using two methods: Two Way Ranging (TWR) and Time Difference of Arrival (TDoA). While TDoA offers precision in client ranging, achieving accuracy levels below ten centimeters, TDoA may necessitate the deployment of a minimum of four anchors (e.g., Access Points (APs)) whose locations are known to enable multilateralization of a client's location. Additionally, TDoA client tracking and ranging may be inaccurate when the client is not positioned within a designated region (e.g., area covered by a sufficient number of anchors in LoS), when there is insufficient link budget, and/or when the client is NLOS. Similar limitations are encountered with TWR.

Phase-Difference-Of-Arrival (PDOA) assisted Angle Of Arrival (AOA) may enable the calculation of the two-dimensional position of an asset with communication involving only a single anchor. Consequently, PDOA assisted AOA may be implemented in environments in which the deployment of multiple anchors with LoS and/or adequate link budget to cover the area of desired coverage is not possible or otherwise impractical. The UWB devices described herein may utilize PDOA assisted AOA to provide accurate ranging and/or client location tracking with a single anchor.

For typical indoor environments, APs that function as anchors for client positioning and ranging are usually mounted on ceilings to increase the probability of LoS scenarios with other APs. Ceiling mounted APs typically utilize antennas with omnidirectional radiation patterns, and AP elements are positioned in a linear antenna array with low isolation between them. Omnidirectional elements positioned in a linear array can lead to angle ambiguity between the two planes separated by displacement vector between any two elements used to perform PDOA, resulting in inaccurate ranging and/or false location determinations of clients. Therefore, the UWB antenna array system described herein may include an antenna architecture designed for use with PDOA, for example to reduce angle ambiguity and/or improve overall accuracy of client location tracking and ranging.

The UWB antenna array system may have uniform gain across an entire bandwidth (e.g., 500 MHz bandwidth) in both azimuth and elevation while maintaining low group delay variation. The UWB system may also provide adequate link budget to have proper coverage for anchors, clients, and/or assets. The antenna element feed point structure may have low insertion loss (i.e., higher gain) and a direct attachment to the RF transmission line. The UWB system may also include an antenna deployment that reduces angle ambiguity and improves the accuracy of client location tracking and ranging.

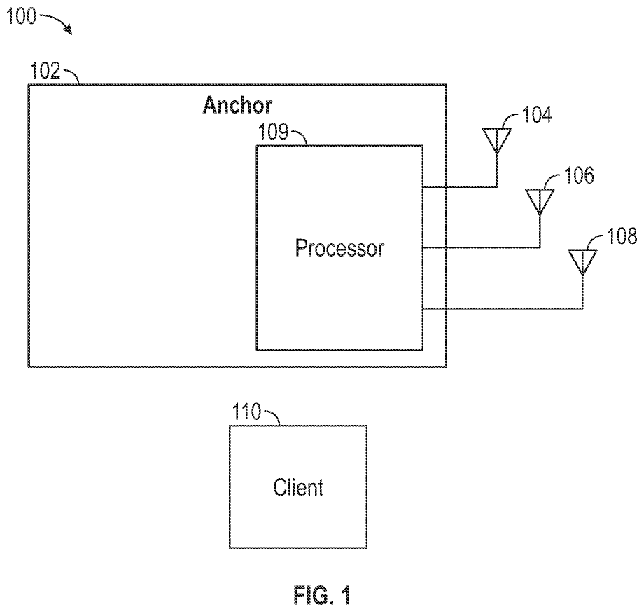

FIG. 1 is a block diagram of an operating environment 100. The operating environment 100 may include an anchor 102 with a first antenna 104, a second antenna 106, a third antenna 108, and a processor 109. The operating environment 100 may also include a client 110. There may be more anchors 102 and/or clients 110 in the operating environment 100 in other examples.

The anchor 102 may be an AP with UWB communication capabilities. The first antenna 104, the second antenna 106, and the third antenna 108 may be omnidirectional antennas able to transmit and/or receive signals using UWB protocols (e.g., transmit to and receive from the client 110). For example, the anchor 102 may be operable for UWB in channel 9 (i.e., 7,737.6 MHz to 8,236.8 MHz, Bandwidth 500 MHZ) to improve the anchor's 102 ability to perform PDOA and/or PDOA assisted AOA with higher accuracy and/or reduced location error variance. The anchor 102 may additionally support TDoA and TWR protocols. The processor 109 may process signals the first antenna 104, the second antenna 106, and/or the third antenna 108 receive, perform calculations, actions, and run programs for the anchor 102 to operate, instruct or otherwise cause the first antenna 104, the second antenna 106, and/or the third antenna 108 to transmit signals, and/or the like.

The anchor 102 may have a different number of omnidirectional antennas in other embodiments. For example, the anchor 102 may have a single antenna and be capable of performing Two Way Ranging (TWR) and Downlink (DL) and Uplink (UL) TDoA. In another example, the anchor 102 may have two antennas and be capable of performing PDOA assisted AOA with the assistance of an additional anchor. In this example, the anchor 102 has three antennas, the first antenna 104, the second antenna 106, and the third antenna 108, and may be capable of performing standalone PDOA assisted AOA.

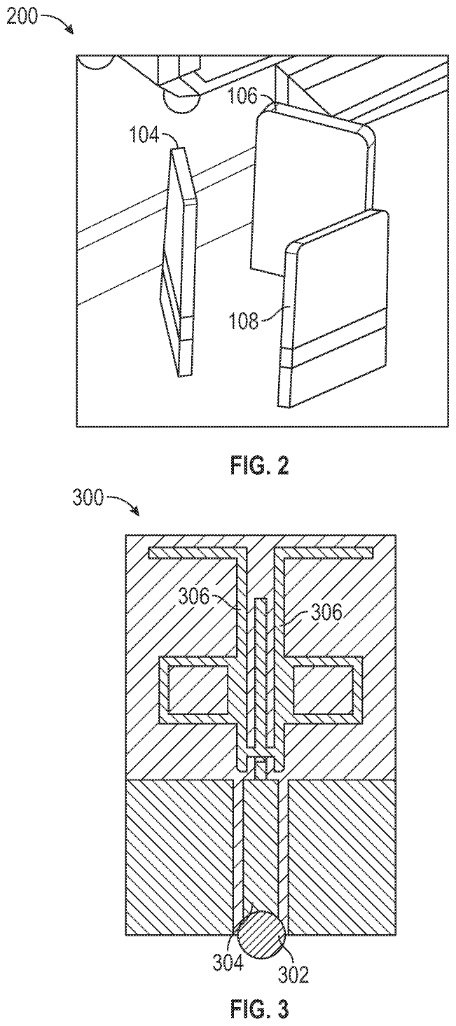

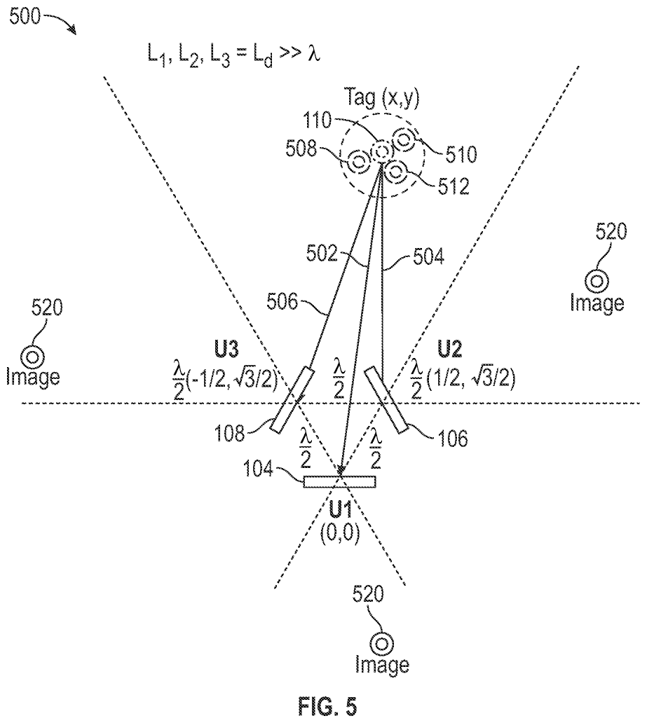

FIG. 2 is a perspective view of a UWB antenna array system 200 for UWB ranging. The UWB antenna array system 200 may include the first antenna 104, the second antenna 106, and the third antenna 108 arranged in a triangular formation. For example, the first antenna 104, the second antenna 106, and the third antenna 108 are arranged in an equilateral triangular formation and maintaining one half of a wavelength distance between the feed point (shown in FIG. 3) of each antenna. The distances between the first antenna 104, the second antenna 106, and the third antenna 108 are shown in further detail in FIG. 5.

The arrangement of the first antenna 104, the second antenna 106, and the third antenna 108 enables the anchor 102 to calculate PDOA with reference to at most three separate displacement vectors at sixty degrees to each other antenna. The arrangement may enable the anchor 102 to perform angle ambiguity resolution using just the measurements from two of the antennas and use the measurements from the other antenna to reduce the error in the calculation. Therefore, the antenna arrangement in an equilateral triangular formation with one half wavelength distance between the feed point of each antenna effectively creates additional plane of measurement for the anchor 102 when the anchor 102 performs client ranging and location tracking (e.g., for the client 110). The arrangement can also improve the accuracy of PDOA measurements by reducing angle ambiguity, leading to reducing error variance (e.g., false location, ghost location).

FIG. 3 is a block diagram of a UWB antenna 300. The UWB antenna 300 may be the first antenna 104, the second antenna 106, and the third antenna 108. The UWB antenna 300 may include a feed point 302 and a feed line 304 connecting the UWB antenna 300 to other components of the anchor 102, and antennas 306.

The UWB antenna 300 is designed to have uniform gain across the 500 MHz bandwidth in both azimuth and elevation angles. The UWB antenna 300 also maintains low group delay variation (e.g., less than 100 picoseconds) across the entire bandwidth and spatial coverage to enable accurate PDOA measurements. Thus, the UWB antenna 300 may be utilized for two-dimensional ranging and three-dimensional ranging with clients and other devices.

The UWB antenna 300 may also be sized to fit in low profile devices. For example, the UWB antenna 300 may be twelve millimeters wide and eighteen millimeters tall. The length of the feed line 304 may be designed to be as short as possible to lower insertion loss and phase delay variation. The antennas 306 may include a resonator structure to lower return loss (e.g., at 7.5 GHZ).

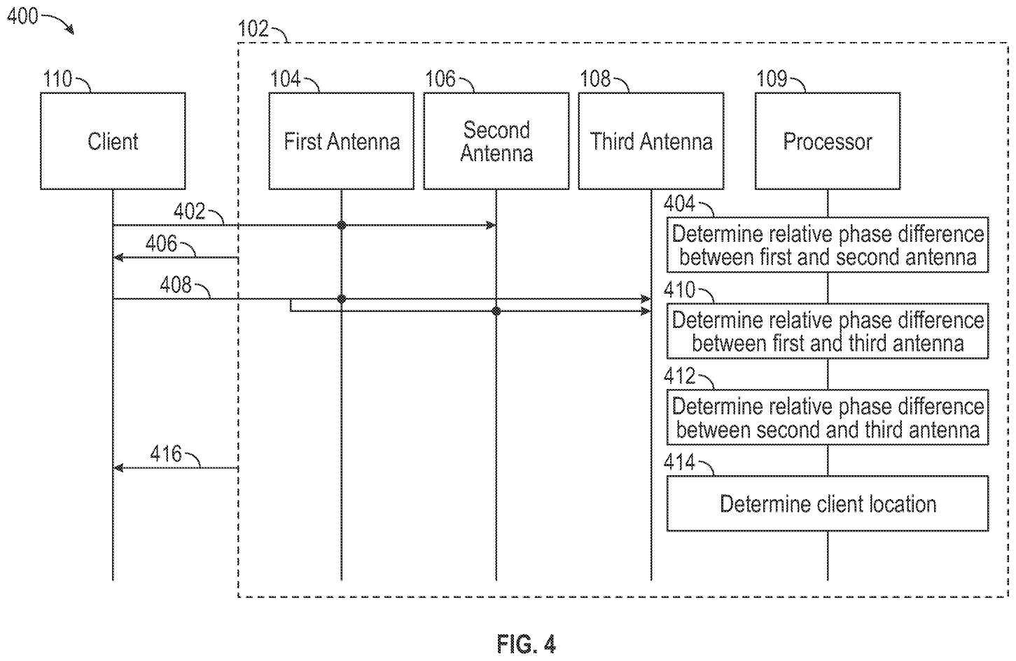

FIG. 4 is a signal diagram of a UWB ranging signal process 400. The UWB ranging signal process 400 may be between the client 110 and the anchor 102. The UWB ranging signal process 400 may be performed so the anchor 102 can determine a position of the client 110 using UWB signals exchanged between the anchor 102 and the client 110. The UWB ranging signal process 400 may be performed using the signals of a typical Double-Sided (DS)-TWR ranging signal process.

The client 110 may initiate the UWB ranging signal process 400 by transmitting a poll signal 402 to the anchor 102. The anchor 102 may receive the poll signal 402 via the first antenna 104 and the second antenna 106. The anchor 102 may receive initiating signals (e.g., first signals from a client, first signals for a ranging signal process, etc.) via the first antenna 104 and the second antenna 106 by default in some examples and other combinations of antennas in other examples. A receiver of the anchor 102 may control which antennas receive signals. Once the anchor 102 receives the poll signal 402, the processor 109 may perform operation 404 and determine the relative PDOA between the first antenna 104 and the second antenna 106. To determine the relative PDOA between the first antenna 104 and the second antenna 106, the processor 109 may compare the time the first antenna 104 receives the poll signal 402 to the time the second antenna 106 receives the poll signal 402, compare the phases of the waveform of the poll signal 402 at the times the first antenna 104 and the second antenna 106 receive the poll signal 402, compare the angle of arrival of the poll signal 402 at the first antenna 104 and the second antenna 106, and/or the like.

The anchor 102 may then transmit a response signal 406 to the client 110. The client 110 may record the reception time the client 110 receives the response signal 406 and transmit a final signal 408 that includes the reception time to the anchor 102. The first antenna 104 and the third antenna 108 may receive a first portion of the final signal 408, and the second antenna 106 and the third antenna 108 may receive a second portion of the final signal 408. For example, the first antenna 104 and the third antenna 108 may receive a portion of the final signal 408 including a Synchronization Header (SHR), and the second antenna 106 and the third antenna 108 may receive a portion of the final signal 408 including a Scrambled Timestamp Sequence (STS).

The processor 109 may perform operation 410 and determine the relative PDOA between the first antenna 104 and the third antenna 108 based on when the first antenna 104 and the third antenna 108 receive the first portion of the final signal 408, the phase of the waveform of the first portion of the final signal 408 when the first antenna 104 and the third antenna 108 receive the first portion of the final signal 408, the angle of arrival of the first portion of the final signal 408 when the first portion of the final signal 408 receive the first portion of the final signal 408, and/or the like. The processor 109 may also perform operation 412 and determine the relative PDOA between the second antenna 106 and the third antenna 108 based on when the second antenna 106 and the third antenna 108 receive the second portion of the final signal 408, the phase of the final signal 408 when the second antenna 106 and the third antenna 108 receive the second portion of the final signal 408, the angle of arrival of the second portion of the final signal 408 when the second antenna 106 and the third antenna 108 receive the signal, and/or the like. Therefore, the processor 109 determines the relative PDOA between (i) the first antenna 104 and the second antenna 106, (ii) the first antenna 104 and the third antenna 108, and (iii) the second antenna 106 and the third antenna 108.

The processor 109 may then perform operation 414 and determine the location of the client 110. During the UWB ranging signal process 400, the processor 109 may determine two individual coarse displacement measurements and identify the minimum of the two. The processor 109 may use the minimum individual coarse displacement measurement for the positioning calculation.

The processor 109 may also determine path length differences between (i) the first antenna 104 path length and the second antenna 106 path length, (ii) the first antenna 104 path length and the third antenna 108 path length, and (iii) the second antenna 106 path length and the third antenna 108 path length, using the carrier frequency of the communication channel and the relative PDOAs determined in operation 410, operation 412, and operation 414.

The processor 109 may then determine candidate client locations of the client 110. For example, the processor 109 may use the relative PDOAs, path length differences, the minimum coarse displacement measurement, and/or the like to determine the candidate locations of the client 110. In some embodiments, the candidate locations of the client 110 may be determined according to a candidate client location equation, equation 1 shown below:

$$Xijk = \{ ( x 21 A , y 21 A ) , ( x 21 B , y 21 B ) \} , \\ \{ ( x 31 A , y 31 A ) , ( x 31 B , y 31 B ) \} , \{ ( x 32 A , y 32 A ) , ( x 32 B , y 32 B ) \} \qquad ( 1 )$$

In equation 1, Xijk represents three sets of two coordinates (i.e., first set {(x21A, y21A), (x21B, y21B)}, second set {(x31A, y31A), (x31B, y31B)}, and third set {(x32A, y32A), (x32B, y32B)}) and i, j, and k are equal to zero or one, with a zero corresponding to A coordinates A and one corresponding to B coordinates. For example, X010 would indicate A coordinates for the first set, B coordinates for the second set, and C coordinates for the third set. Therefore, X010 would equal {(x21A, y21A)}, {(x31B, y31B)}, {(x32A, y32A)}.

Because to the cosine of the angle between the client 110 and the anchor 102 along the plane of the displacement vectors between the antennas is symmetric, two position solutions are derived per measurement between pairs of antennas (x, ty). Therefore, the A coordinates are coordinates for a first position solution of the measurement and the B coordinates are coordinates for a second position solution of the measurement. x21A indicates position in the x-axis based on measurements of the first antenna 104 and the second antenna 106 for the A coordinates, and y21A indicates position in the y-axis based on measurements of the first antenna 104 and the second antenna 106 for the A coordinates. x21B indicates position in the x-axis based on measurements of the first antenna 104 and the second antenna 106 for the B coordinates, and y21A indicates position in the y-axis based on measurements of the first antenna 104 and the second antenna 106 for the B coordinates. Similarly, x31A indicates position in the x-axis based on measurements of the first antenna 104 and the third antenna 108 for the A coordinates, y31A indicates position in the y-axis based on measurements of the first antenna 104 and the third antenna 108 for the A coordinates, x31B indicates position in the x-axis based on measurements of the first antenna 104 and the third antenna 108 for the B coordinates, and y31A indicates position in the y-axis based on measurements of the first antenna 104 and the third antenna 108 for the B coordinates. x32A indicates position in the x-axis based on measurements of the second antenna 106 and the third antenna 108 for the A coordinates, y32A indicates position in the y-axis based on measurements of the second antenna 106 and the third antenna 108 for the A coordinates, x32B indicates position in the x-axis based on measurements of the second antenna 106 and the third antenna 108 for the B coordinates, and y32A indicates position in the y-axis based on measurements of the second antenna 106 and the third antenna 108 for the B coordinates.

As described above, two position solutions are derived per measurement between pairs of antennas. When rotating the solutions back to the coordinate system of the anchor 102, one of the solutions (xA or xB) will accurately indicate the location of the client 110 and the other is a false image or otherwise incorrect location. Thus, the processor 109 may determine which solution accurately indicates the location of the client 110.

To determine the correct solution and select accurate candidate client locations to use, the processor 109 may use a distance squares optimization function. The distance squares optimization function may be represented by equation 2, shown below:

$$Cijk = {( {( x 21 i - x 31 j )}^{2} + {( x 31 j - x 32 k )}^{2} + {( x 21 i - x 32 k )}^{2} )}^{2} \qquad ( 2 )$$

In equation 2, Cijk represents the cost function, and i, j, and k are equal to zero or one. The processor 109 may iterate through all combinations of the sets of data. Since indices i, j, and k are binary values, there are eight possible combinations represented from zero to seven in three bits (000, 001, . . . 111). The processor 109 may generate a cost function list (i.e., Cijk=[C000, C001, . . . , C111], calculate the costs using equation 2, and determine the minimum cost in the list to identify the most likely cluster of real solutions. The processor 109 may select three position solutions as the most likely cluster of solutions to estimate the location of the client 110.

The processor 109 may the perform a weighted average of the three selected position solutions to improve the resolution of the measurement and reduce the impact of outlier measurements. The processor 109 may calculate the weights used in the weighted average as an inverse displacement from the mean location. In some examples, the processor 109 may determine the phase error maximum at the edges of the reference planes and may discard the solution with the maximum error plane at the edges. The processor 109 may then use the two remaining solutions to determine the location of the client 110.

The anchor 102 may also transmit a location signal 416 to the client 110 to inform the client 110 of its determined location. In other examples, the anchor 102 may transmit the location signal 416 to another device. The UWB ranging signal process 400 may conclude after the anchor 102 transmits the location signal 416.

FIG. 5 is a block diagram of a client position determination environment 500. The client position determination environment 500 may include the first antenna 104, the second antenna 106, and the third antenna 108 operating to enable the anchor 102 to determine the location of the client 110. The client position determination environment 500 shows the first antenna path length 502, the second antenna path length 504, and the third antenna path length 506. The client position determination environment 500 also shows the first antenna 104, the second antenna 106, and the third antenna 108 arranged in the equilateral triangular formation with one half wavelength distance between the feed point 302 of each antenna.

The anchor 102 may determine the location of the client 110 according to the methods described above and generate the first estimated position 508, the second estimated position 510, the third estimated position 512, and the false positions 520. The anchor 102 may identify that the first estimated position 508, the second estimated position 510, the third estimated position 512 are accurate and the false positions 520 are inaccurate using the methods described above.

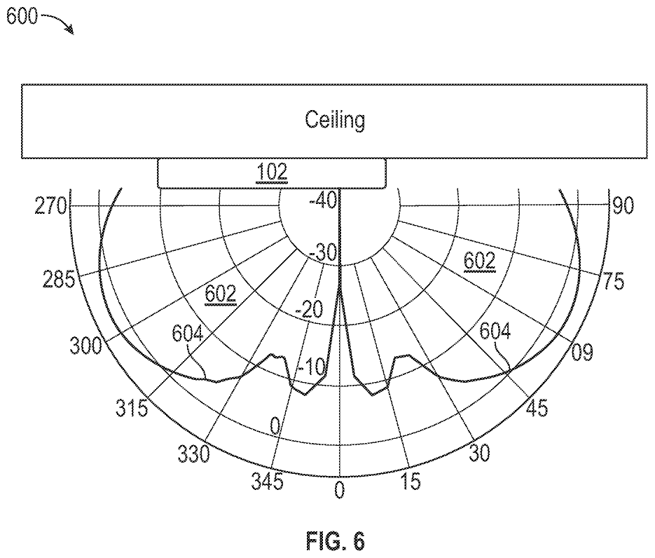

FIG. 6 is a side view 600 of a UWB antenna range. The side view 600 shows the anchor 102 mounted to a ceiling. The anchor's 102 coverage area 602, defined by coverage limits 604, is also shown.

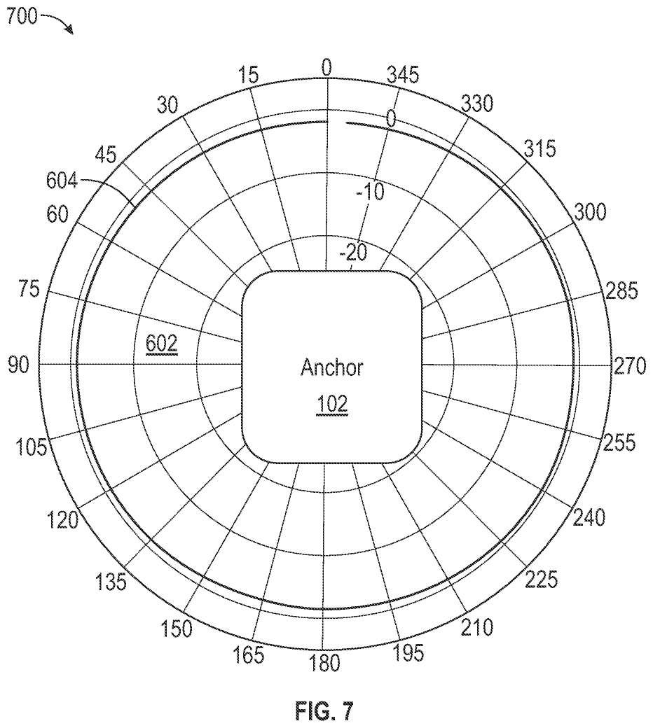

FIG. 7 is an overhead view 700 of a UWB antenna range. The overhead view 700 shows the anchor 102 mounted to a ceiling. The anchor's 102 coverage area 602, defined by coverage limits 604, is also shown.

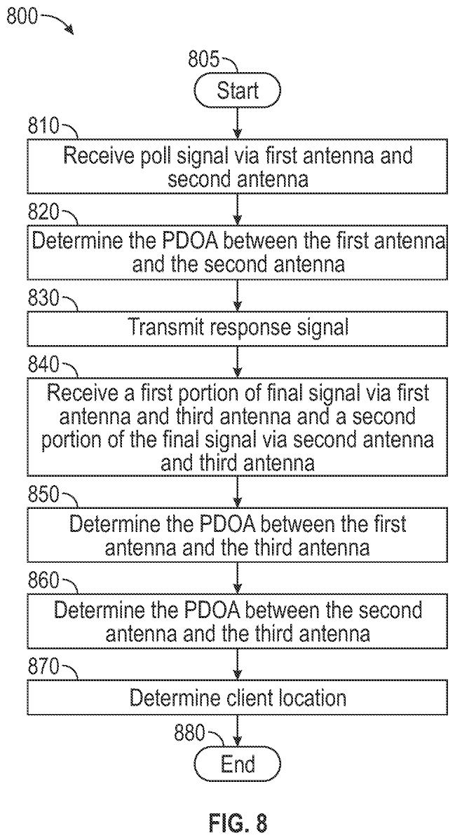

FIG. 8 is a flow chart of a method 800 for UWB ranging. The method 800 may begin at starting block 805 and proceed to operation 810. In operation 810, a poll signal is received via a first antenna and second antenna. For example, the client 110 transmits a UWB signal, and the anchor 102 receives the UWB signal via the first antenna 104 and the second antenna 106.

In operation 820, the PDOA between the first antenna and the second antenna is determined. For example, the anchor 102 determines the PDOA between the first antenna 104 and the second antenna 106. The anchor 102 may determine the PDOA between the first antenna 104 and the second antenna 106 based on the times the first antenna 104 and the second antenna 106 receive the poll signal 402 received in operation 810, compare the phases of the waveform of the poll signal 402 at the times the first antenna 104 and the second antenna 106 receive the poll signal 402, compare the angle of arrival of the poll signal 402 at the first antenna 104 and the second antenna 106, and/or the like.

In operation 830, a response signal is transmitted. For example, the anchor 102 transmits a response signal 406 to the client 110. In operation 840, a first portion of a final signal is received via the first antenna and the third antenna, and a second portion of the final signal is received via the second antenna and the third antenna. For example, the anchor 102 receives the final signal 408 from the client 110. The anchor 102 may use a receiver to select which antennas receive a signal and therefore enable the first antenna 104 and the third antenna 108 to receive the first portion of the final signal 408 and the second antenna 106 and the third antenna 108 to receive the second portion of the final signal 408. The client 110 may transmit the final signal 408 in response to receiving the response signal 406 transmitted in operation 830.

In operation 850, the PDOA between the first antenna and the third antenna is determined. For example, the anchor 102 determines the PDOA between the first antenna 104 and the third antenna 108. The anchor 102 may determine the PDOA between the first antenna 104 and the third antenna 108 based on when the first antenna 104 and the third antenna 108 receive the first portion of the final signal 408, the phase of the waveform of the first portion of the final signal 408 when the first antenna 104 and the third antenna 108 receive the first portion of the final signal 408, the angle of arrival of the first portion of the final signal 408 when the first portion of the final signal 408 receive the first portion of the final signal 408, and/or the like.

In operation 860, the PDOA between the second antenna and the third antenna is determined. For example, the anchor 102 determines the PDOA between the second antenna 106 and the third antenna 108. The anchor 102 may determine the PDOA between the second antenna 106 and the third antenna 108 based on when the second antenna 106 and the third antenna 108 receive the second portion of the final signal 408, the phase of the final signal 408 when the second antenna 106 and the third antenna 108 receive the second portion of the final signal 408, the angle of arrival of the second portion of the final signal 408 when the second antenna 106 and the third antenna 108 receive the signal, and/or the like.

In operation 870, the location of the client is determined. For example, the anchor 102 determines the location of the client 110 using the methods and equations described above. The method 800 may conclude at ending block 880.

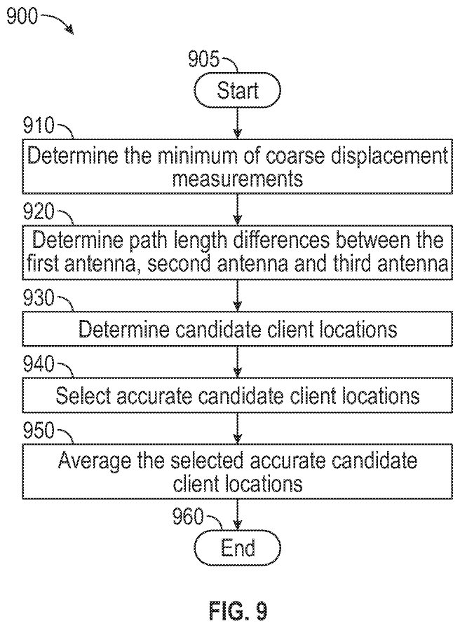

FIG. 9 is a flow chart of a method 900 for determining client location using UWB ranging. The method 900 may be used to perform operation 870 and determine the location of a client. The method 900 may begin at starting block 905 and proceed to operation 910. In operation 910, the minimum of coarse displacement measurements is determined. For example, the anchor 102 may have determined two coarse displacement measurements and determine the measurement with a minimum distance.

In operation 920, path length differences are determined for the first antenna, the second antenna, and the third antenna. For example, the anchor 102 determines the between (i) the first antenna 104 path length and the second antenna 106 path length, (ii) the first antenna 104 path length and the third antenna 108 path length, and (iii) the second antenna 106 path length and the third antenna 108 path length, using the carrier frequency of the communication channel and the relative PDOAs determined in operation 820, operation 850, and operation 860.

In operation 930, candidate client locations are determined. For example, the anchor 102 may use the relative PDOAs, path length differences, the minimum coarse displacement measurement, and/or the like to determine the candidate locations of the client 110. The anchor 102 may use the methods and equations (i.e., equation 1) described above to determine the candidate client locations.

In operation 940, accurate candidate client locations are selected. For example, the anchor 102 determines accurate candidate client locations using the methods and equations (i.e., equation 2) described above.

In operation 950, the selected accurate candidate client locations are averaged. For example, the anchor 102 averages the selected accurate candidate client locations to determine the location of the client 110. The anchor 102 may perform a weighted average to determine the location of the client 110, and the anchor 102 calculate the weights used in the weighted average as an inverse displacement from the mean location. In some examples, the anchor 102 may determine the phase error maximum at the edges of the reference planes and may discard the solution with the maximum error plane at the edges. The anchor 102 may then use the two remaining solutions to determine the location of the client 110. The method 900 may conclude at ending block 960.

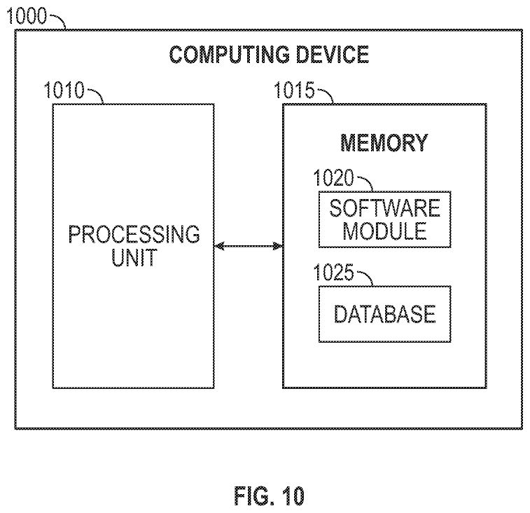

FIG. 10 is a block diagram of a computing device 1000. As shown in FIG. 10, computing device 1000 may include a processing unit 1010 and a memory unit 1015. Memory unit 1015 may include a software module 1020 and a database 1025. While executing on processing unit 1010, software module 1020 may perform, for example, processes for UWM ranging and client tracking with respect to FIG. 1, FIG. 2, FIG. 3, FIG. 4, FIG. 5, FIG. 6, FIG. 7, FIG. 8, and FIG. 9. Computing device 1000, for example, may provide an operating environment for the anchor 102, the client 110, and the like. The anchor 102, the client 110, and the like may operate in other environments and are not limited to computing device 1000.

Computing device 1000 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1000 may comprise any computer operating environment, such as hand-held devices, multiprocessor systems, microprocessor-based or programmable sender electronic devices, minicomputers, mainframe computers, and the like. Computing device 1000 may also be practiced in distributed computing environments where tasks are performed by remote processing devices. The aforementioned systems and devices are examples, and computing device 1000 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 1000 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving a poll signal from a client via a first antenna and a second antenna;
determining a Phase-Difference-of-Arrival (PDOA) between the first antenna and the second antenna based on the poll signal;
transmitting a response signal to the client;
receiving a first portion of a final signal via the first antenna and a third antenna and a second portion of the final signal via the second antenna and the third antenna;
determining a PDOA between the first antenna and the third antenna based on the first portion of the final signal;
determining a PDOA between the second antenna and the third antenna based on the second portion of the final signal; and
determining a location of the client based on the PDOA between the first antenna and the second antenna, the PDOA between the first antenna and the third antenna, and the PDOA between the second antenna and the third antenna.

2. The method of claim 1, wherein the first antenna, the second antenna, and the third antenna are Ultra-Wideband (UWB) omnidirectional antennas.

3. The method of claim 1, wherein the first antenna, the second antenna, and the third antenna are in an equilateral triangular formation and spaced at one half of a wavelength distance between feed points of the respective antennas.

4. The method of claim 1, wherein determining the location of the client comprises:
determining a minimum measurement of a plurality of coarse displacement measurements;
determining path length differences between the first antenna, the second antenna, and the third antenna;
determining candidate client locations based on the PDOA between the first antenna and the second antenna, the PDOA between the first antenna and the third antenna, the PDOA between the second antenna and the third antenna, the minimum measurement, and the path length differences;
selecting one or more accurate candidate client locations; and
averaging the selected one or accurate candidate client locations.

5. The method of claim 4, wherein determining the candidate client locations comprises:
computing the candidate client locations using a candidate client location equation.

6. The method of claim 4, wherein selecting the one or more accurate candidate client locations comprises:
using a distance squares optimization function to identify a cluster of accurate candidate client locations.

7. The method of claim 4, wherein averaging the selected one or more accurate candidate client locations comprises:
determining weights based on an inverse displacement from a mean location of the client; and
determining a weighted average on the selected one or more accurate candidate client locations using the weights.

8. The method of claim 4, further comprising:
determining a phase error maximum at edges of reference planes; and
discarding a candidate client location with the phase error maximum.

9. A system comprising:
a memory storage; and
a processing unit coupled to the memory storage, wherein the processing unit is operative to:
receive a poll signal from a client via a first antenna and a second antenna;
determine a Phase-Difference-of-Arrival (PDOA) between the first antenna and the second antenna based on the poll signal;
transmit a response signal to the client;
receive a first portion of a final signal via the first antenna and a third antenna and a second portion of the final signal via the second antenna and the third antenna;
determine a PDOA between the first antenna and the third antenna based on the first portion of the final signal;
determine a PDOA between the second antenna and the third antenna based on the second portion of the final signal; and
determine a location of the client based on the PDOA between the first antenna and the second antenna, the PDOA between the first antenna and the third antenna, and the PDOA between the second antenna and the third antenna.

10. The system of claim 9, wherein the first antenna, the second antenna, and the third antenna are Ultra-Wideband (UWB) omnidirectional antennas.

11. The system of claim 9, wherein the first antenna, the second antenna, and the third antenna are in an equilateral triangular formation and spaced at one half of a wavelength distance between feed points of the respective antennas.

12. The system of claim 9, wherein to determine the location of the client comprises to:
determine a minimum measurement of a plurality of coarse displacement measurements;
determine path length differences between the first antenna, the second antenna, and the third antenna;
determine candidate client locations based on the PDOA between the first antenna and the second antenna, the PDOA between the first antenna and the third antenna, the PDOA between the second antenna and the third antenna, the minimum measurement, and the path length differences;
select one or more accurate candidate client locations; and
average the selected one or accurate candidate client locations.

13. The system of claim 12, wherein to determine the candidate client locations comprises to:
compute the candidate client locations using a candidate client location equation.

14. The system of claim 12, wherein to select the one or more accurate candidate client locations comprises to:
use a distance squares optimization function to identify a cluster of accurate candidate client locations.

15. The system of claim 12, wherein to average the selected one or more accurate candidate client locations comprises to:
determine weights based on an inverse displacement from a mean location of the client; and
determining a weighted average on the selected one or more accurate candidate client locations using the weights.

16. A non-transitory computer-readable medium that stores a set of instructions which when executed perform a method executed by the set of instructions comprising:
receiving a poll signal from a client via a first antenna and a second antenna;
determining a Phase-Difference-of-Arrival (PDOA) between the first antenna and the second antenna based on the poll signal;
transmitting a response signal to the client;
receiving a first portion of a final signal via the first antenna and a third antenna and a second portion of the final signal via the second antenna and the third antenna;
determining a PDOA between the first antenna and the third antenna based on the first portion of the final signal;
determining a PDOA between the second antenna and the third antenna based on the second portion of the final signal; and
determining a location of the client based on the PDOA between the first antenna and the second antenna, the PDOA between the first antenna and the third antenna, and the PDOA between the second antenna and the third antenna.

17. The non-transitory computer-readable medium of claim 16, wherein the first antenna, the second antenna, and the third antenna are Ultra-Wideband (UWB) omnidirectional antennas.

18. The non-transitory computer-readable medium of claim 16, wherein the first antenna, the second antenna, and the third antenna are in an equilateral triangular formation and spaced at one half of a wavelength distance between feed points of the respective antennas.

19. The non-transitory computer-readable medium of claim 16, wherein determining the location of the client comprises:
determining a minimum measurement of a plurality of coarse displacement measurements;
determining path length differences between the first antenna, the second antenna, and the third antenna;
determining candidate client locations based on the PDOA between the first antenna and the second antenna, the PDOA between the first antenna and the third antenna, the PDOA between the second antenna and the third antenna, the minimum measurement, and the path length differences;
selecting one or more accurate candidate client locations; and
averaging the selected one or accurate candidate client locations.

20. The non-transitory computer-readable medium of claim 19, wherein determining the candidate client locations comprises:
computing the candidate client locations using a candidate client location equation.
